(19) United States
(12) Patent Application Publication
(10) Pub. No.: US 2020/0320898 A1
(43) Pub. Date: Oct. 8, 2020

(54) Systems and Methods for Providing Reading Assistance Using Speech Recognition and Error Tracking Mechanisms

(71) Applicant: Rally Reader, LLC, Atherton, CA (US)

(72) Inventors: Andrea Johnson, Atherton, CA (US); Matthew Johnson, Atherton, CA (US)

(21) Appl. No.: 16/376,789

(22) Filed: Apr. 5, 2019

(51) Int. Cl. G09B 17/00; G10L 15/22; G10L 15/08; G09B 5/02; G09B 5/04

(52) U.S. Cl. CPC G09B 17/006; G10L 15/22; G09B 5/04; G09B 5/02; G10L 15/08

(57) ABSTRACT

Methods and systems for providing reading assistance to a user are provided. One or more written words are transmitted for display to a user's computing device, for the user to read aloud. An audio segment is received from the user's computing device. The audio segment comprises the user's spoken (audible) words as the user read aloud the one or more written words. The audio segment is processed by utilizing speech recognition to determine if the user's spoken word or words match with the one or more written words.

### FIELD OF INVENTION

Embodiments of the present disclosure pertain to systems and methods for an electronic book (e-book) reader application utilizing speech recognition. In particular, but not by way of limitation, the present technology provides systems and methods for a reading application that utilizes speech recognition in order to detect if a user is accurately reading one or more words aloud from a given text.

### BACKGROUND

The ability to read is an extraordinary gift that allows for a person to expand their mind and explore new worlds and new ideas through written text. However, for many humans, adults and children alike, they struggle with learning how to read written words from a text accurately and fluently. This in turn may cause them frustration, stress, sadness, and anxiety. People who struggle with learning how to read may be reluctant to practice reading. They lack the confidence to practice reading on their own. In other cases, some people may wish to improve their ability to read different types of text. By way of a non-limiting example, they may wish to improve their ability to read text found in technical books, which may be more complex and difficult to read for the average reader.

### SUMMARY

According to some embodiments, the present technology may be directed to methods for providing reading assistance to a user, comprising (a) transmitting for display to a user's computing device one or more written words for the user to read aloud; (b) receiving an audio segment from the user's computing device, the audio segment comprising the user's spoken words as the user read aloud the one or more written words; (c) processing the audio segment by utilizing speech recognition to determine if the user's spoken words matches with the one or more written words; and (d) visually indicating on the user's computing device whether the user's spoken words matched with the one or more written words.

According to some embodiments, the present technology may be directed to methods for providing reading assistance to a user, comprising (a) transmitting for display to a user's computing device one or more warm up words for the user to read aloud; (b) receiving a first audio segment from the user's computing device, the first audio segment comprising the user's spoken words that were spoken as the user read aloud the one or more warm up words; (c) processing the first audio segment by utilizing speech recognition to determine if the user's spoken words match with the one or more warm up words; (d) transmitting for display to the user's computing device one or more written words from a text for the user to read aloud; (e) receiving a second audio segment from the user's computing device, the second audio segment comprising the user's spoken words that were spoken as the user read aloud the one or more written words from the text; (f) processing the second audio segment by utilizing speech recognition to determine if the user's spoken words match with the one or more written words from the text; and (g) visually indicating on the user's computing device whether the user's spoken words matched with the one or more written words from the text.

According to some embodiments, the present technology may be directed to methods for providing reading assistance to a user, comprising: (a) transmitting for display to a user's computing device one or more written words for the user to read aloud; (b) indicating to the user, by means of a visual indicator, a selected written word of the one or more written words, the selected written word to be read aloud by the user; (c) receiving an audio segment from the user's computing device, the audio segment comprising the user's reading aloud of the selected written word; (d) processing the audio segment by utilizing speech recognition to determine if the user's reading aloud of the selected written word matches with the selected written word; and (e) upon determining that the sounds of the user's reading aloud of the selected written word matches with the sounds of the selected written word, automatically advancing the visual indicator to the next written word immediately following the selected written word, so as to indicate that the user is to read the next written word.

According to some embodiments, the present technology may be directed to methods for providing reading assistance to a user, comprising: (a) transmitting for display to a user's computing device one or more warm up words for the user to read aloud; (b) receiving a first audio segment from the user's computing device, the first audio segment comprising the user's spoken words that were spoken as the user read aloud the one or more warm up words; (c) processing the first audio segment by utilizing speech recognition to determine if the user's spoken words match with the one or more warm up words; (d) transmitting for display to the user's computing device one or more written words from a text for the user to read aloud; (e) receiving a second audio segment from the user's computing device, the second audio segment comprising the user's spoken words that were spoken as the user read aloud the one or more written words from the text; (f) processing the second audio segment by utilizing speech recognition to determine if the user's spoken words match with the one or more written words from the text; and (g) visually indicating on the user's computing device whether the user's spoken words matched with the one or more written words from the text.

According to some embodiments, the present technology may be directed to an e-book reader system for providing reading assistance to a user, the system comprising: (a) a memory for storing executable instructions providing reading assistance to a user; and (b) a processor configured to execute the instructions, the instructions being executed by the processor to: transmit for display to a user's computing device a text comprising one or more written words for the user to read aloud; indicate to the user, by means of a visual indicator, a selected word of the one or more written words, the selected word to be read aloud by the user; receive an audio segment from the user's computing device, the audio segment comprising the user's reading aloud of the selected written word; process the audio segment by utilizing speech recognition to determine if the user's reading aloud of the selected written word matches with the selected written word; automatically advance the visual indicator to the next written word immediately following the selected written word, so as to indicate that the user is to read the next written word; track an error made by the user, an error comprising a word in the user's spoken words that does not match with the one or more written words; store an occurrence of the error in a database; store a portion of the audio segment of the user's voice that included the error; and replay the portion of the audio segment of the user's voice that included the error when requested by the user.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the technology so as not to obscure the disclosure with details that will be readily apparent to those of ordinary skill in the art having the benefit of the description herein.

FIG. 1 is a schematic architecture diagram of an example system constructed in accordance with the present disclosure.

FIG. 2 shows a schematic diagram of an exemplary reader system.

FIG. 3 is a flowchart of an example method of the present disclosure.

FIG. 4 is a flowchart of another example method of the present disclosure.

FIG. 5 is a flowchart of a further example method of the present disclosure.

FIG. 6 illustrates a computer system used to execute embodiments of the present technology.

### DETAILED DESCRIPTION

The following detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The present disclosure provides systems and methods for a reader application that utilizes speech recognition in order to detect if a user is accurately reading one or more words out loud from a given text. In some embodiments, the reader application is an electronic book (e-book) reader application.

Many people, adult and children alike, have a desire to practice reading on a regular basis. They wish to read words aloud accurately from a text. The text can be provided from any source of the written word, including but not limited to, books, articles, flashcards, pamphlets, magazines, journals, trade papers, newspapers, news, newspaper clippings, news aggregators, Internet forum messages, one or more webpages from the Internet, and any combination thereof.

The present disclosure provides for an AI-enabled reading application that uses machine learning and speech to text technology, and provides real-time feedback to the user. The application can also track the user's progress on rates of fluency and accuracy. That is, the application can indicate and also track errors that the user made while reading one or more written words that were provided to the user to read aloud. The present disclosure utilizes artificial intelligence and speech recognition such that it is possible for a user to learn how to read independently and privately, and the user can still have the benefit of knowing whether or not they read aloud accurately. Further, the present disclosure provides for tracking mechanisms to determine how many words are read per minute by the user, the amount of time the user read during that given session or for a particular day, and to track fluency. Fluency, as used in this present disclosure, not only refers to the words read per minute by a user, but also the user's ability to read in a natural sounding voice such that a user sounds natural and does not sound like stilted or robotic. Furthermore, fluency addresses the ability to read with the correct voice inflection (such as in the case of reading the end of sentence versus reading the end of a question) and the ability to read with pauses to indicate the end of a sentence or a comma in the text.

The present disclosure further provides methods and systems that track and improve accuracy. Accuracy is the percentage of the number of words read that were spoken accurately by the user the first time versus the total number of words read by the user. For example, if a user currently read 300 words but only 4 of those 300 words were spoken accurately the first time, then the user has an accuracy of 4/300 words times 100% which is equal to 1.33%.

Other metrics to be tracked in the service of improving reading include, but are not limited to; number of minutes spent reading per day, number of words read per day, words per/minute read per day, trouble words, mastered words (words that were “trouble words” and have been mastered by the user), persistence (number of words the user attempted more than once and then got correct), days when the user completed the warm up sequence, days within the user completed the cool down sequence, the device on which the user engaged with the application, whether a user used headphones w/microphone, and the time of day when the user used the application. The user will have access to these personal metrics and will be able to view them on a daily basis, over time, and relative to peer groups. The user will be able to share metrics with other people including, but not limited to, peers, parents, teachers, or tutors. Metrics, along with other factors including, but not limited to visual presentation of reading material, may be used to make personalized recommendations to users regarding ways to increase reading fluency and accuracy.

Furthermore, the present disclosure includes methods and systems of indicating to the user the next word or punctuation that is to be read. This provides the user with support for visual tracking of the next word or punctuation to be read aloud. The present disclosure also includes methods and systems to indicate to the user if they skipped a word, read a word inaccurately, failed to pause for a punctuation mark (such as a comma or period), and/or failed to use the correct inflection of voice for a punctuation mark (such as a question mark or an exclamation mark). With the present disclosure, detection of reading errors made by a user may also include tracking and storing of the words that were difficult to the user to speak. Words that were difficult for the user to speak or read aloud will be referred herein as “trouble words.” The present disclosure allows for the recording of trouble words for subsequent learning methods utilizing the present disclosure. Also, where the user correctly read aloud a word, this too will be recorded. Thus, errors that the user made while reading aloud and words that the user read correctly aloud will both be recorded in the user's own voice, such that those recordings may be replayed at a later time for educational purposes and encouragement mechanisms. Occurrences of reading errors of the user can be stored in a database. Both portions of audio segments in the user's own voice that included the errors, as well as portions of audio segments of the user reading words aloud correctly, can also be stored. All of these and more will be described in greater detail herein.

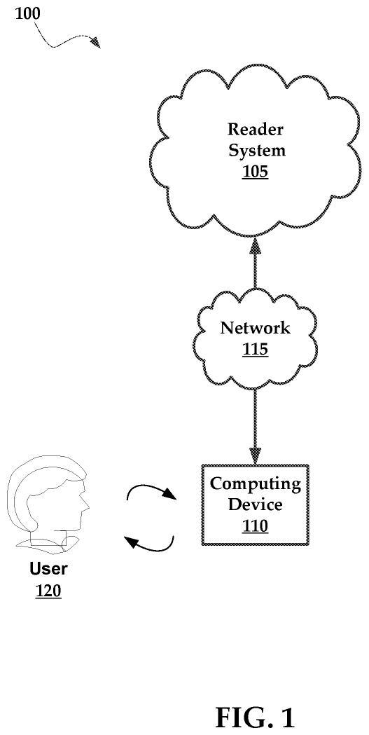

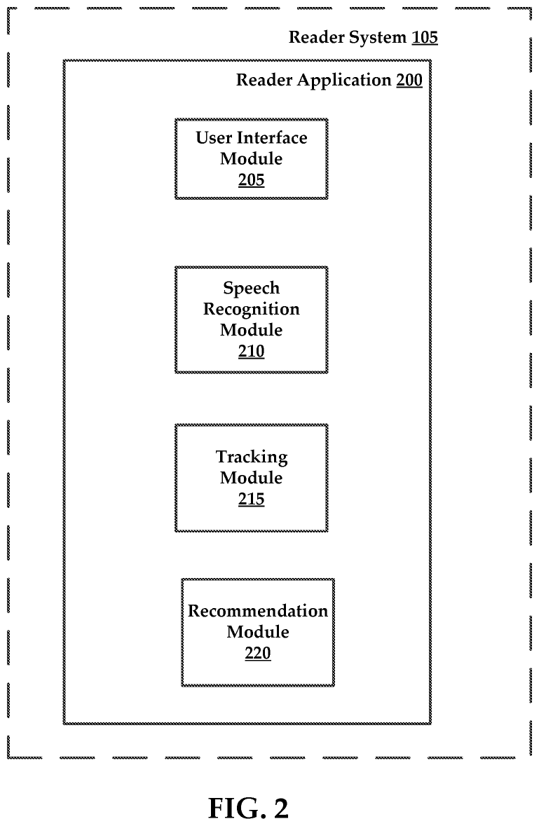

FIG. 1 illustrates an exemplary system 100 for practicing aspects of the present technology. The system 100 may include a reader system 105 that may include one or more local servers or web servers, or any combination thereof, along with digital storage media device such as databases. The system 100 may also include a network connection 115 and a computing device 110. The computing device 110 may be utilized by a user 120 to communicate with the reader system 105 as set forth later herein. The reader system 105 may also function as a cloud-based computing environment in accordance with various embodiments of the present technology. The computing device 110 may communicatively couple with the reader system 105 via a network 115. The network 115 is a system of interconnected computer networks, such as the Internet. Additionally or alternatively, the network 115 may be a private network, such as home, office, and enterprise local area networks (LANs). Details regarding the operation of the reader system 105 will be discussed in greater detail with regard to FIG. 2.

In general, a cloud-based computing environment is a resource that typically combines the computational power of a large grouping of processors and/or that combines the storage capacity of a large grouping of computer memories or storage devices. For example, systems that provide a cloud resource may be utilized exclusively by their owners, such as Google™ or Yahoo!™; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depend on the type of business associated with the user.

The computing device 110 may be required to be authenticated with the reader system 105 via credentials such as a username/password combination, or any other authentication means that would be known to one of ordinary skill the art with the present disclosure before them.

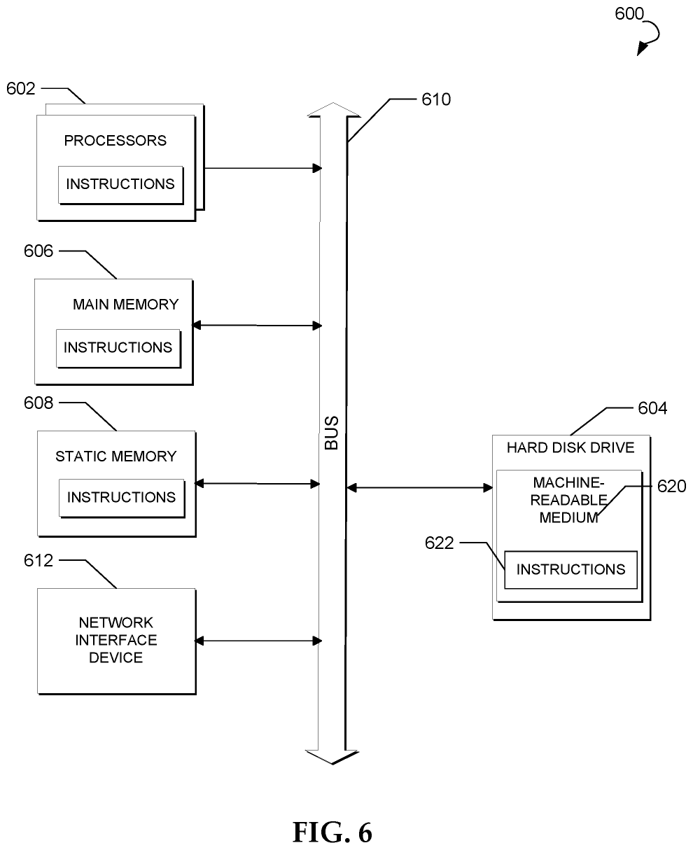

The computing device 110 include at least one of a personal computer (PC), hand held computing system, telephone, mobile computing system, workstation, tablet, phablet, wearable, mobile phone, a smart phone, server, minicomputer, mainframe computer, or any other computing system. Computer systems associated with the reader system 105 and the computing device 110 are described further in relation to the computing system 600 in FIG. 6.

In some embodiments, the computing device 110 may include a web browser (or similar software application) for communicating with the reader system 105. By way of a non-limiting example, the computing device 110 is a tablet or a smart phone running a client (or other software application). Additionally or alternatively, the computing device 110 can be a PC running a web browser. Additionally or alternatively, the computing device 110 may comprise one or more of a toy (such as a computerized toy, a phone toy, a mobile toy, or a plush toy), a game, a gaming device, and the like.

FIG. 2 illustrates a block diagram of an exemplary reader application, hereinafter application 200, which is constructed in accordance with the present disclosure. The application 200 may reside within memory of the computing device 110 and/or the reader system 105. The application 200 may comprise a plurality of modules such as a user interface module 205, a speech recognition module 210, a tracking module 215 and a recommendation module 220. It is noteworthy that the application 200 may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the application 200 may include or be executed on separately configured web servers.

The user 120 may interact with the application 200 via one or more graphical user interfaces that are generated by the user interface module 205. Additionally, one or more written words of a text may be provided to the computing device 110 of the user 120 via one or more graphical user interfaces for the user 120 to read aloud. In some embodiments, the one or more written words of a text may be displayed on the computing device 110 of the user 120 in a way such as to mimic or mirror the appearance of one or more pages of a physical book.

In some embodiments, the features and functions of the present disclosure can be implemented on a website or via a web application that utilizes an Internet connection. Some embodiments described herein utilize a web application that is installed on a mobile phone, but one skilled in the art can appreciate that the services can be furnished on a website that is access via a web browser on a desktop computer or on the mobile phone without the installation of a web application. Systems and methods described herein also can utilize one or more of the components of the computer system 600 of FIG. 6.

According to some embodiments, execution of the application 200 by a processor of the computing device 110 may cause the user interface module 205 of the application 200 to transmit for display to the computing device 110 one or more written words for the user to read aloud. The one or more written words can be a portion of a given text (such as a word, a sentence or a chapter of an e-book), or the entirety of a given text, such as the whole e-book. The user will then read aloud the one or more written words into a microphone or any other audio listening component of the computing device 110. Additionally, the reader system 105 will receive an audio segment from the user's computing device 110. The audio segment comprises the user's spoken word or words captured by the computing device 110 as the user read the one or more written words. Additionally or alternatively, the audio segment comprises the user's spoken syllables and/or the user's spoken phonemes as captured by the computing device 110 as the user read the one or more written words.

Using the speech recognition module 210, the application 200 will then process the audio segment by using speech recognition capabilities to determine if the user's spoken word or words match with the one or more written words that were previously transmitted for display to the user's computing device 110. As will be described later on in further detail, the tracking module 215 of the application 200 can track certain metrics associated with the user's reading of written words, including but not limited to, metrics regarding fluency, accuracy, and automaticity, as well as reading benchmarks. Also, as will be described later on in further detail, the recommendation module 220 of the application 200 will generate and transmit personalized user recommendations to the computing device 110, based on the user's profile, the user's tracked metrics, and the user's past readings or reading sessions of written words from text. Also, personalized user recommendations may be based on one or more of the user's use of warm up tool, the user's use of cool down tool, the user's use of ‘stop the clock’ guided breathing and/or stretching exercises, the time of day at which the user read, the device on which the user read, and the user's use of an additional device such as headphones with a microphone. One skilled in the art may also recognize that the speech recognition may be accomplished local serves, remote servers, or in a hybrid manner using both local and remote servers.

A user's profile may be stored by the reader system 105. The user's profile may include one or more parameters, such as the user's reading level, age, gender, school grade, and the user's selections of fonts, font sizes and contrasts for written words to be displayed on the user's computing device 110. For instance, a user may choose different fonts and/or font sizes that may be visually less distracting. Also, the user may choose to read text using different contrasts, such as navy on white or black on white, for visual aid. For some, reading with a particular font, font size and/or particular contrast will increase the accuracy of their reading of the text. Thus, if the reader system 105 determines that users with similar profiles have improved accuracy in their reading that is attributable to a given font, font size and/or contrast, the recommendation module 215 of the application 200 may send a recommendation to user to use the given font, font size and/or contrast. The recommendation may be displayed on the user's computing device 110 using the user interface module 205. By way of a non-limited example, the recommendation may say “Based on your profile and profiles of other users with similar profiles, you may wish to use Courier point size 15 font. Others with similar profiles to you had improved accuracy in their reading using this font.”

Also the application 200 can recommend that a user select a font with a heavier baseline, to help visually track. The heavier baseline of the font along the bottom of the letters may help users, such as dyslexic users, to track and read more accurately. A font with a heavier baseline appears to a user that as if a regular font is applied on the top portion of a particular letter, while a bold font is applied on the bottom portion of the same letter.

Also the application 200 may allow for the user to turn on a feature called a reading wave. If the reading wave feature is turned on, while the user is reading, the reading wave can be adapted to show an emphasis on the words that the user should be placing more emphasis when reading. The reading wave can be configured to magnify or zoom in on the written words that the user should place more emphasis while reading aloud the written words.

Further, using the recommendation module 215, the application 200 can make recommendations based on the user's past readings. By way of a non-limiting example, if the child user selects a book that has a reading level that is beyond their reading level, the reader system will provide this information to the child user, their teacher and/or the child's parents, notifying them that the book selected by the child has many new words that the child has not read before. The application 200 will alert or send a push notification to the parent, indicating that the child user may struggle in reading the book. However, the application 200 is designed to allow for the user to have universal choice to select any text they wish to read, as the reader system is not designed to discourage a user from reading in any way.

The recommendation module 215 can also provide a recommendation to the child based on books that the child's teacher recommended. Also the recommendation module 215 can recommend other books to the user by assigning a personalized score to one or more texts or e-books. The recommendation module 215 can assign the score on a personalized basis based on the user's past reading, how difficult the upcoming text will be for the user to read, how many words in the upcoming text has the user read correctly, or at least what percentage of the words have the read correctly, in past readings, including the past exposure of certain written words to the user. Also the recommendation module 215 can assign the score based on how complicated are the words to pronounce in a given book and how many syllables are in the words of the text. Also, the recommendation module 215 reviews how many words in a given e-book are irregular or sight words that will be difficult for the particular user to read. Further, the recommendation module 215 can make recommendations to the user on what e-books the user should consider selecting, based on their past readings.

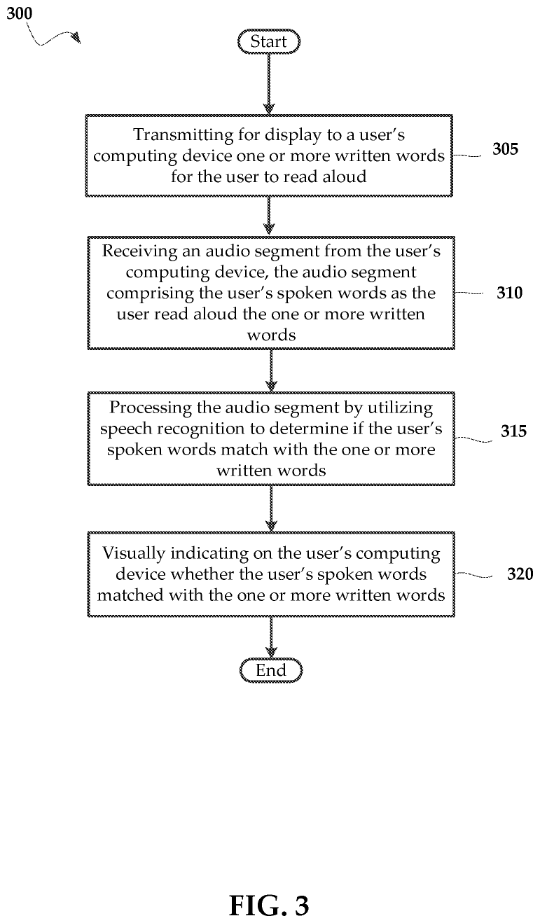

Now turning to FIG. 3, FIG. 3 is a flowchart of an exemplary method 300 for providing reading assistance to a user. The method 300 may comprise a step 305 of transmitting for display to a user's computing device one or more written words for the user to read aloud. As described previously, the one or more written words can be from any text. In some embodiments, an electronic book (e-book) or a portion of the e-book (such as a predetermined number of pages or a chapter) may be transmitted to the user's computing device. The user can then read aloud the one or more written words from the e-book. As will be described further, the user interface module of the reader system may assist the user in reading aloud the one or more written words by visually indicating which word is to be read next by the user. The visual indicator can be in the form of any visual aid, such as a highlight or bolding of the word to be read, a dot above or below the word, an underlining of the word, a different coloring of the word from the rest of the written words, and the like.

Additionally, the method 300 may comprise a step 310 of receiving an audio segment from the user's computing device, the audio segment comprising the user's spoken words as the user read aloud the one or more written words. In some embodiments, the audio segment is captured by a microphone or similar audio or listening component of the computing device. Further, the method 300 may comprise a step 315 of processing the audio segment by utilizing speech recognition to determine if the user's spoken words match with the one or more written words. In other words, the audio segment is processed using speech to text technology to see if the user's spoken (vocal) words as recorded in the audio segment match the one or more written words that the user was supposed to read. Furthermore, the method 300 may include a step 320 of visually indicating on the user's computing device whether the user's spoken words matched with the one or more written words.

If there is a match between the user's spoken words and the one or more written words, then the application will make the determination that the user accurately read the one or more written words, will measure this accuracy using the accuracy formula mentioned above, and store the accuracy measurement in the user's profile with the help of a database associated with the reader system. Also the system can store a portion of the audio segment that included the user's spoken words that matched with the one or more written words.

If, on the other hand, the application detects that at least one of the user's spoken words did not match with the one or more written words, then the user interface module of the application will visually indicate that an error occurred. The application will visually indicate which word was read aloud incorrectly by indicating which of the user's spoken words did not match with the one or more written words. For instance, if the user skipped a word, then the reader system will indicate that a word was skipped by highlighting the word, underlining the word or changing the color of the skipped word so as to flag the user's attention to the skipped word. If the user skipped a punctuation mark, then the punctuation mark will be highlighted the word, underlining, or the color of the punctuation mark will be changed so as to flag the user's attention to the skipped punctuation mark. For example, if a user did not pause at a comma, the comma may be highlighted, underlined, bolded or the color of the comma may be changed from black to red, so that the user's attention is drawn to the skipped punctuation mark. Also, by way of a non-limiting example, if the user said a written word incorrectly, the error will be shown to the user by highlighting the word, underlining the word or changing the color of the trouble word so as to flag the user's attention to the trouble word. The present disclosure allows for a first color to be used for indicating the word to be read aloud, a second color to be used to indicate a word or a punctuation mark that was skipped, and a third color to be used to indicate when a word was mispronounced or read aloud incorrectly by the user.

As mentioned previously, the speech recognition utilized in the methods disclosed herein help to track reading accuracy of the user. It should be noted that conventional speech recognition techniques can oftentimes use an unlimited vocabulary. That is, the issue that arises when using conventional speech recognition is it has to be prepared to recognize any number of possible words that may be spoken by the user. Conventional speech recognition technology does not know what the user's next spoken word will be and so there may be a time delay in recognizing and matching the user's spoken word with one or more written words of a given text.

In contrast, in some embodiments, the speech recognition, in the systems and methods disclosed herein, utilizes and recognizes a limited vocabulary based on the anticipated words to be spoken by the user as they read the one or more written words of a given text. This is because the speech recognition module of the application already knows the written words that are being displayed to the user on their computing device when the application is launched. Thus, in certain embodiments of the present disclosure, the speech recognition is configured to recognize and match a limited vocabulary of words. The speech recognition module already knows and is prepared to recognize the next word that it is trying to match with the user's spoken word as the user reads the next written word aloud. Thus, the application's speech recognition module can be configured to limit the scope of the vocabulary being used to the words that the user is supposed to say next, such as configuring the speech recognition module to recognize a vocabulary set to a predetermined number. The vocabulary can be of any number, including but not limited to a vocabulary of one or a vocabulary of 10, a vocabulary of any number between 10 and 50, and so forth. The predetermined number of words can be selected from a group of one, two, three, four, five, six, seven, eight, nine, and ten words. The configurable limit of on the numbers of words for the vocabulary to be recognized by the speech recognition module may be based on a number of factors, including but not limited to, the speed that the user is reading written words. By limiting the vocabulary used by the speech recognition in the methods disclosed herein, the application is able to increase the accuracy of the speech recognition.

By way of a non-limiting example, the speech recognition module is initially set to recognize and match a vocabulary of ten words at a time. Thus, the speech recognition is rather accurate since it is expecting ten different words. The ten different words are those anticipated written words that the reader is to read next using the application. In some embodiments, the speech recognition module is configured to recognize similar phonemes. In further embodiments, the vocabulary may be adjusted, based upon a detection by the application that a user has paused. That is, if a uses pauses while reading aloud one or more written words, during those pauses, the speech recognition can continue to build the vocabulary. The building of the vocabulary may be based on anticipated written words, as presented in a given text (such as the next two pages of an e-book).

Yet another aspect of the speech recognition utilized in the present disclosure is that it is capable to handle the situation where a user is written word syllable by syllable as if the user is sounding out the word. The speech recognition utilized in the present disclosure can accept the syllable by syllable, or phoneme by phoneme, input by the user, filter the syllables or phonemes as spoken by the user, pass these syllables or phonemes as sounds to the speech recognition module, and by utilizing speech recognition, reassemble the syllables to detect what is the word that is being said by the user. In other words, the speech recognition determines if the collective number of syllables matches a given word. Conventional speech recognition cannot perform this reassembly of syllables or phonemes and recognition. An example of this would be a user reading aloud the word “phenomenon.” As the user is speaking each syllable of the written word, syllable by syllable, the speech recognition would reassemble the syllables to detect the user is saying the word “phenomenon.” In further embodiments, the speech recognition of the application can synthesize a user's spoken phonemes and/or spoken syllables (which may be considered as parts of a whole word), such that the spoken phonemes and/or spoken syllables are transformed into whole words (which can be viewed as the user's spoken words of the one or more written words). This can be done in order to check for reading accuracy.

A further aspect of the speech recognition utilized in the methods presented herein is that the speech recognition module can determine based on the advance presentation of written words, which written words may be more difficult for the user to read aloud. The speech recognition module of the application may make this determination based on a number of factors, including but not limited to, the user's previous challenges or difficulties in reading a particular word, the complexity of the word, and a review of the user's fluency score relative to a fluency score of one or more similar users (whose profiles are similar to the user) who had difficulty with that same word The speech recognition may “look ahead” to upcoming text that is to be read by the user, and may extract written words from the upcoming text which are likely to be more difficult for the user to read and/or pronounce. The speech recognition combines the user's past reading of the word (have they been exposed to the word? Did they have trouble reading the word?), the complexity of the word in general, and the complexity of the word to the community of users with a similar reading level capability and their difficulty with that word, to determine if one or more written words in the upcoming text will be more difficult for the user to read aloud.

It should be noted that complexity of a word may come in different forms. Sometimes the complexity in a word is the fact that the word is multisyllabic, like the word “phenomenal.” Sometimes the complexity of a given word is that it does not follow pronunciation conventions, including sight words. An example of this is the word “gnome.”

It should also be noted that this application can provide reading assistance to users who have learning differences. For instance, dyslexic children who may use this application to practice their reading may skip words from time to time, so the application feature of indicating which written word was skipped is very helpful for them. Furthermore, for a dyslexic child, currently the only true feedback they receive is from a teacher who times them in reading one or more written words and who notes the reading errors that the child made during that timed reading. This session of timed reading does not happen frequently enough, though.

Dyslexic children need to practice on a regular basis, to improve their reading skills, and they need to be able to practice reading independently. Most dyslexic children also want to know if their reading is improving over time, and how many words did they read correctly in a given reading session. The present disclosure addresses these needs of dyslexic children, by providing them a vehicle to practice reading independently on a regular basis and providing them also with their accuracy and fluency metrics, just to name a few.

Dyslexic child users will benefit from the present disclosure since with the reader application, the users can see their data in real time and track their progress. The data regarding the user's reading skills as obtained by the systems described herein are far more accurate than the data collected by a child's teacher in a timed reading. A user can also see trends concerning their reading accuracy and fluency based on their usage of the application. For instance, by way of a non-limiting example, a user may see that if they only read twice a week without a warm up sequence, they may not have improved, but if they read three times a week with a warm up sequence and a cool down sequence, the user may discover that their reading skills improved. Also a user can see that users with similar profiles saw a huge improvement if they read using the application a set number of times a week. The application will also recommend to the user that based on users with similar profiles, if the user read a given number of times a week, they might see a huge improvement on their reading skills.

Further, the application might recommend that based on users with similar profiles, if the user read a given number of minutes a day or a week, they might see a huge improvement on their reading skills. The application may also recommend to the user to add warm up sequences and/or cool down sequences, based upon the reading improvements experienced by users with similar profiles who did warm up and cool down sequences. By way of a non-limiting example, after a week, the application will provide a personalized recommendation. For instance, the application may provide a message to the user that states: “You did great this week, here's how you did.” Then the application will provide the user with their statistics regarding accuracy and fluency that week. The application may also provide a personalized recommendation to the user for upcoming reading sessions.

Also, a user may be encouraged by the application to continue reading a predetermined level of reading day to day, so that they can maintain a streak. The application will measure and store the time spent by the user in actively reading using the application, and this information may be depicted to the user in the form of a progress bar. By using a progress bar, the user can see how much active reading they should be doing for that given day to maintain their reading streak.

Also, besides giving feedback, providing recommendation and encouraging the users to read actively, the system can determine if the user is frustrated by the elevated level of stress in their voice. If the user is stressed or if the user says “time out”, the application may stop the clock, or give the user the option to stop the clock, so to speak, and make a recommendation to the user on a guided breathing exercise, a stretching exercise, or some other mechanism for the user to relax, calm down and eventually return to active reading aloud when the user is not as stressed. Such breaks suggested by the application to the user may improve the user's reading results and accuracy. The guided breathing exercise may include a physical component, such as having the user tap his/finger to synchronize inhalation and exhalation. By way of a non-limiting example, the application can indicate to the user that the user should inhale while tapping his/her finger to a count of four, hold one's breath while tapping one's finger for a count of four, and exhale while tapping one's finger to a count of six. Multi-modal or multi-sensory techniques can be particularly effective in teaching people with learning challenges like dyslexia. The application will track whether the guided breathing or stretching exercises had an impact on the user's reading accuracy or fluency.

Also for child users of the present technology, the systems and methods disclosed herein for providing reading assistance allow for parents of child users to track and be assured that their children are reading regularly for a set number of minutes of a given day. In other words, the system measures and tracks the number of minutes that a child user reads using the application. The system also may provide a push notification to the parent if the child is struggling with their reading session, based on the system's ability to detect and track the child's reading accuracy in real-time. That is, the system can detect if the user has stress indicators in their voice while using the reader application. The application can recognize from the user's recorded voice in real time if there is elevated levels of stress, in the context of learning how to read written words aloud. If the child is stressed while using the application and this is detected by the application, the application will then send a timely push notification the parent that the child is stressed and that they may wish to check on the child at that time.

As mentioned before, the application tracks accuracy of a user which is an important metric for most users who want to improve their reading skills. To that end, in an effort to increase accuracy, the application allows for a warm up sequence and cool down sequence. The goal of the application is to decrease the user's reading errors by utilizing the warm up and cool down sequences.

The warm up and cool down sequences address a common issue for people who are learning how to read and people who have learning differences, such as dyslexics, which is the issue that information on how to read certain words may be stored in the user's short term memory in their brain. It may take a longer period of time for this information to enter into a user's long term memory. Building automaticity, the ability to see words and read them quickly, is important to increase accuracy and fluency in reading, so with a warm up exercise, a person may have a higher chance of reading words correctly, increasing their reading accuracy, and building their reading comprehension.

In other words, a user may launch the application on their computing device, and prior to reading written words from a text (such as an e-book), the user is provided with a warm up sequence first that includes one or more virtual flashcards or cue cards that are displayed on the display of the user's computing device. The flashcards or cue cards may each show a word. During the warm up sequence, the user is given an opportunity to practice words that they had difficulties in reading in the recent past, based on the tracking of words that the user read incorrectly in the past. Also, the warm up exercise may include words that other users with similar profiles have read incorrectly in the past or words that the user has not encountered beforehand. The difficult words that may be presented to the user for them to practice in a warm up exercise may be trouble words. In some embodiments, if the user completed in the cool down sequence in the prior session, then the user's audio responses to questions including “what was the main idea in the text you read?” or “What do you think will happen next in the story?”, then that day's warm up session will include the option to listen to the recorded responses that the user made during the prior cool down session.

Furthermore, during the warm up exercise, it is personalized based on the user's reading level and the user's past readings. The trouble words may include words that the user will encounter in the upcoming pages of the text to be read aloud by the user (such as the upcoming 10 pages of an e-book). Also the user may be given a set number of attempts to read a trouble word aloud before the application will read the word to the user. A set number of attempts assigned to the user may be based on the user's reading level (such as 3 attempts, 5 attempts, or any number of attempts).

If the user exceeds the number of attempts to accurately read a written word, the application will provide the user with several additional assistance or teaching options. The application will provide the user with the option to show the user a syllabic or phonetic version of the word, the option to skip the written word, the option to show the user a syllabized version of the word, the option to hear the word said correctly by the user in the user's own voice if the user has previously read the word aloud correctly, the option to hear the written word (in other words, for the written word to be read aloud for the user by the application), a phrase or a sentence, the option to read the word to the user using text to speech, the option to be prompted with a rhyming word, and any combination thereof.

At the end of the warm up sequence, the user has been reminded of how to read the trouble words for their upcoming reading of the written words. Then once the warm up sequence has ended, the application will display the written words of the text where the user last finished reading.

As mentioned previously, the application also improves and builds the user's automaticity of words. Thus, by way of a non-limiting example, if the user sees the word “gnome” in the first warm up sequence, in the one or more written words of the text during a first reading session, and in the first cool down sequence, and also during a second warm up sequence associated with a second reading session, this may improve the user's automaticity regarding the word “gnome.” For some users, they must see the word a number of times before they can automatically recognize the word.

It should also be noted that the reader system is “listening” or determining how quickly the user read the word aloud correctly. If the user read a word such as “gnome” correctly and quickly a certain number of times, then the reader system will gauge that and it may take the word off the list of “trouble words” such that the word “gnome” will not be presented in the next warm up sequence. Similarly, with a multisyllabic word such as the word “phenomenal,” the word may be included in a warm up sequence and a cool down sequence to build a user's automaticity. Many users need to read a trouble word correctly and quickly several times before that word should be removed from that user's list of trouble words. The application will determine how many times a user needs to read the trouble word fluently before that word should be removed from the trouble list.

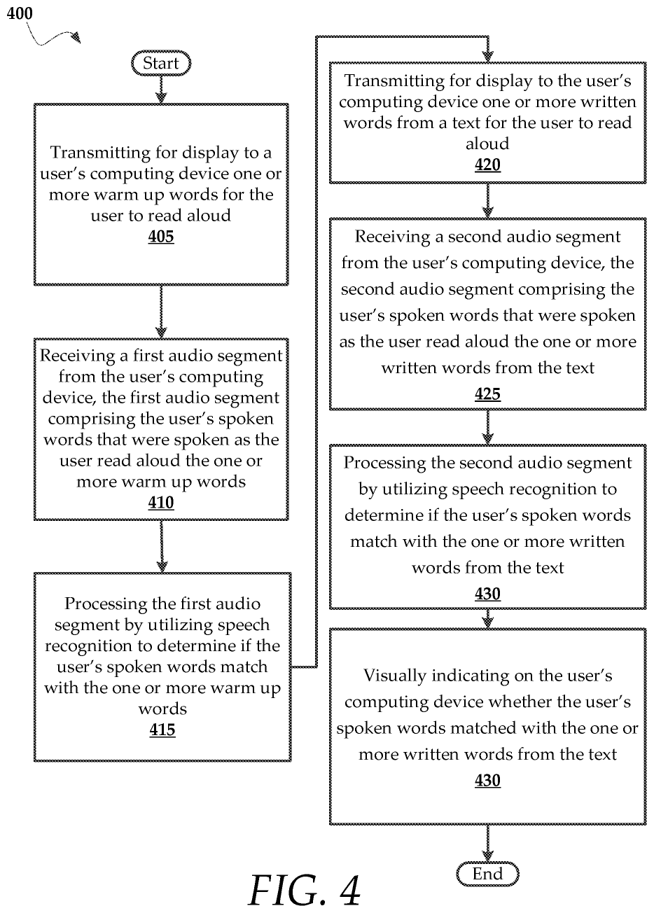

FIG. 4 is a flowchart of a further exemplary method 400 for providing reading assistance to a user. This exemplary method 400 provides the steps for a warm up exercise and a reading session in accordance with various embodiments of the present disclosure. The exemplary method includes a step 405 of transmitting for display to a user's computing device one or more warm up words for the user to read aloud. The method may further include a step 410 of receiving a first audio segment from the user's computing device, the first audio segment comprising the user's spoken words that were spoken as the user read aloud the one or more warm up words. The method continues with a step 415 of processing the first audio segment by utilizing speech recognition to determine if the user's spoken words match with the one or more warm up words. The speech recognition can be adjusted based on the words per minute being read, so the speech recognition function can be configured and set to process any given number of words, such as 100 words per minute or 10 words per minute.

The method 400 further includes a step 420 of transmitting for display to the user's computing device one or more written words from a text for the user to read aloud. The method 400 may also include a step 425 of receiving a second audio segment from the user's computing device, the second audio segment comprising the user's spoken words that were spoken as the user read aloud the one or more written words from the text. The method 400 may continue with a step 430 of processing the second audio segment by utilizing speech recognition to determine if the user's spoken words match with the one or more written words from the text. Finally, the method 400 concludes with a step 435 of visually indicating on the user's computing device whether the user's spoken words matched with the one or more written words from the text.

In some embodiments, the exemplary method 400 may include steps for providing a cool down sequence to the user. The cool down sequence is meant to help the user review trouble words, which may include words that they struggled with or had difficulties in reading accurately during the reading session. The cool down sequence includes the steps of transmitting for display to the user's computing device one or more cool down words for the user to read aloud; receiving a third audio segment from the user's computing device, the third audio segment comprising the user's spoken words that were spoken as the user read aloud the one or more cool down words; and processing the third audio segment by utilizing speech recognition to determine if the user's spoken words match with the one or more cool down words.

In a cool down sequence, the application may provide virtual flashcards or cue cards of trouble words, based on last portion that the user read. Also, in a cool down sequence, the application may also provide an audio prompt where the user is asked a first question such as “What was the big idea of this text?” Then the user can press the record button on the graphical user interface of the application using their computing device. Once the user has recorded their answer, the user's answer to the first question can be converted into text. The user can also be presented with a second question during the cool down sequence, such as “What do you think will happen next in the story?” The user will have a chance to respond to this question and the user's recorded answer to the second question can also converted into text. Then, in the next day's warm up sequence, these two pieces of information or answers of the user can be used as refreshers, such as to remind the user where they were at in the text last time. In further embodiments, the user may answer a multiple choice question posed during the cool down sequence by the application by selecting one of the multiple choice answers provided to the user, and the user's response can then be recorded.

Further, based on the user's feedback of the story as set forth in their answers to the two questions presented in the cool down sequence, that information can be part of the push alert that can be delivered to teachers, parents, and/or coaches. For instance, the child's response to “What was the big idea of this text?” may be forwarded to the child's parent, so that the child's parent can ask the child about the text they read using the application, perhaps during dinner time later that evening. Also, the application may utilize heuristic learning and speech to text technology of the child's feedback, as stated in their answers to the two questions presented in the cool down sequence, to determine whether the child comprehended the text that they just read during the reading session that preceded the cool down sequence.

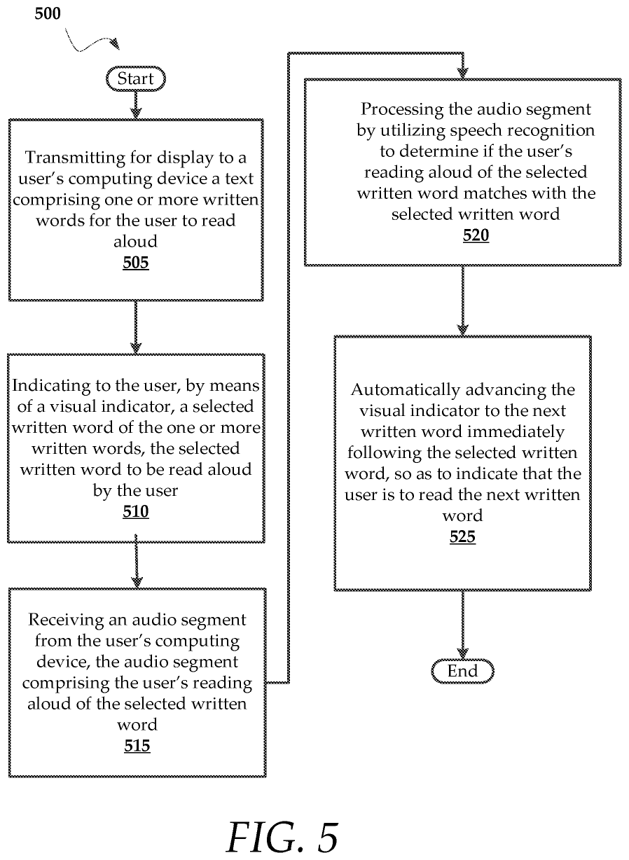

FIG. 5 is a flowchart of another exemplary method 500 for providing reading assistance to a user. The exemplary method 500 begins with a step 505 of transmitting for display to a user's computing device a text comprising one or more written words for the user to read aloud. The exemplary method 500 further includes a step 510 of indicating to the user, by means of a visual indicator, a selected word of the one or more written words, the selected word to be read aloud by the user. The method 500 also includes a step 515 of receiving an audio segment from the user's computing device, the audio segment comprising the user's reading aloud of the selected written word. The method 500 then includes a step 520 of processing the audio segment by utilizing speech recognition to determine if the user's reading aloud of the selected written word matches with the selected written word. The exemplary method 500 concludes with a step 525 of, upon determining that the sounds of the user's reading aloud of the selected written word matches with the sounds of the selected written word, automatically advancing the visual indicator to the next written word immediately following the selected written word, so as to indicate that the user is to read the next written word. Further optional steps include upon determining that the sounds of user's reading aloud of the selected written word do not match with the sounds of the selected written word, by speech recognition, transmitting for display to the user's computing device a notification that the user did not read the selected written word correctly; and transmitting for display on the user's computing device one or more options for the user to select, the options comprising an option for the user to read aloud again the selected written word, an option for the user to receive additional assistance from the application, an option for the user to skip the selected written word altogether, and an option for the selected written word to be read aloud to the user by the application via the user's computing device.

By way of a non-limiting example, imagine that the sentence to be read by the user in the text is “The glass is half full.” The visual indicator will first indicate the user is to read the word “the.” Once the reader system has received an audio segment comprising the user's reading aloud of the word “the,” then the visual indicator will automatically advance to the next written word of “glass,” since the word “glass” immediately follows the word “the.” In other words, at that time, the word “glass” will be highlighted in a different color, highlighted, underlined or somehow visually indicated as the word to be read next. The visual indicator will remain on the word “glass” until the word “glass” is read aloud by the user. In some embodiments, the visual indicator will advance onto the word “is,” which is the next word following the word “glass,” regardless if the user reads the word “glass” correctly the first time. In other embodiments, if the user does not read the word “glass” correctly for a set or configurable number of times for the user to attempt to read the word correctly(for instance, three times), then the user has the option to ask the application for the word “glass” to be read to them.

The set number of times for a user to read a given word may be based on the reading level and/or age of the user. For instance, a young user may be given two tries, whereas a more mature reader may be given five tries. This has to deal with a feature in the application called a “stuck indicator.” The stuck indicator is a configurable way to allow a user to advance in a text (such as an e-book), whether they read a written word correctly or not, with one or more configurable number of times for the user to attempt to reach the word. If the user fails to read the written word correctly, then the reader system will record the word spoken versus the written word on the page, so that every sound bite is recorded along with the written word, for future learning, optimization and data collection.

If a user struggles with reading a written word, and they are stuck, the stuck indicator feature provided by the application will provide the user with several options if the user clicks or taps on the written word displayed on their computing device. The user can choose the option of hearing a phonetic sounding of the word. The user can choose the option of hearing the word cut into phonemes or syllables, as one would see in a dictionary, so that the user can be encouraged to try again to read the written word. In other words, voice recognition may be used on a syllable by syllable basis to determine if a person accurately pronounced a complete word. The user may choose the option of hearing a recording of their own voice saying the word correctly, if in the past the user read the word correctly. The user may also choose the option of hearing a prompting phrase, such as “the word rhymes with . . . ” So, if the written word that the user is struggling to read aloud is the word “cat,” then the user may select the option of hearing a prompting phrase from the application, such as “the word rhymes with the word ‘hat.’”

Also, the application includes the optional feature of word zoom. If the user makes an error repeatedly in reading a written word, such as in the case of inaccurate pronunciation of a word, or based upon user input (such as the user tapping on a selected written word that they are struggling to read), the written word can grow in font size such that the reading environment become a visual distraction-free environment, thereby allowing the user to “zoom in” on the written word and focus on the written word, to increase reading accuracy. The written word that is selected by the user to “zoom in” is enlarged in a font size such that the written word appears to be bigger in size than any of the remaining written words. This option of word zoom can be turned on or off by the user.

FIG. 6 shows a diagrammatic representation of a computing device for a machine in the exemplary electronic form of a computer system 600, within which a set of instructions for causing the machine to perform any one or more of the methodologies discussed herein can be executed. The computer system 600 may be implemented within the computing device 110 and the reader system 105.

In various exemplary embodiments, the computing device operates as a standalone device or can be connected (e.g., networked) to other computing devices. In a networked deployment, the computing device can operate in the capacity of a server or a client machine in a server-client network environment, or as a peer machine in a peer-to-peer (or distributed) network environment. The computing device can be a PC, a tablet PC, a set-top box, a cellular telephone, a digital camera, a portable music player (e.g., a portable hard drive audio device, such as an Moving Picture Experts Group Audio Layer 3 player), a web appliance, a network router, a switch, a bridge, or any machine capable of executing a set of instructions (sequential or otherwise) that specify actions to be taken by that machine. Further, while only a single computing device is illustrated, the term “computing device” shall also be taken to include any collection of computing devices or computers that individually or jointly execute a set (or multiple sets) of instructions to perform any one or more of the methodologies discussed herein.

The example computer system 600 includes a processor or multiple processors 602, a hard disk drive 604, a main memory 606, and a static memory 608, which communicate with each other via a bus 610. The computer system 600 may also include a network interface device 612. The hard disk drive 604 may include a computer-readable medium 620, which stores one or more sets of instructions 622 embodying or utilized by any one or more of the methodologies or functions described herein. The instructions 622 can also reside, completely or at least partially, within the main memory 606 and/or within the processors 602 during execution thereof by the computer system 700. The main memory 606 and the processors 602 also constitute machine-readable media.

While the computer-readable medium 620 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory (RAM), Read-Only Memory (ROM), and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems.

In some embodiments, the computer system 600 may be implemented as a cloud-based computing environment, such as a virtual machine operating within a computing cloud. In other embodiments, the computer system 600 may itself include a cloud-based computing environment, where the functionalities of the computer system 600 are executed in a distributed fashion. Thus, the computer system 600, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as a client device, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk, any other optical medium, any other physical medium with patterns of marks or holes, a RAM, a Programmable Read-Only Memory, an Erasable Programmable Read-Only Memory (EPROM), an Electrically Erasable Programmable Read-Only Memory, a FlashEPROM, any other memory chip or data exchange adapter, a carrier wave, or any other medium from which a computer can read.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

1. A method for providing automated reading assistance to a user, comprising:
transmitting for display to a user's computing device a plurality of written words of a given text for the user to read aloud;
receiving a first audio segment from the user's computing device, the first audio segment comprising the user's spoken words as the user reads aloud a first subset of the plurality of written words of the given text;
detecting a pause while the user reads aloud one or more of the plurality of written words;
processing the first audio segment received from the user's computing device by utilizing a first limited vocabulary for electronic speech recognition to determine if the user's spoken words match with the first subset of the plurality of written words, the first limited vocabulary for electronic speech recognition comprising a configurable number of known upcoming words in the given text;
visually indicating on the user's computing device whether the user's spoken words from the first audio segment matched with the first subset of the written words; and
building a second limited vocabulary for electronic speech recognition, the second limited vocabulary comprising a configurable number of known upcoming words in the given text that succeed the first subset of the plurality of written words,
wherein the second limited vocabulary for electronic speech recognition is built while the user reads aloud the first subset of the plurality of written words.

2. The method of claim 1, further comprising:
tracking an error made by the user as detected by a processed audio segment, the error comprising a word in the user's spoken words in the processed audio segment that does not match with a corresponding written word in the given text;
storing an occurrence of the error in a database,
storing a portion of the audio segment that included the error.

3. The method of claim 2, wherein the visually indicating further comprises visually indicating which word was read aloud incorrectly by indicating which of the user's spoken words did not match with one or more of the written words on the plurality of written words displayed on the user computing device.

4. The method of claim 1, wherein the visually indicating further comprises visually indicating that the user's spoken word matched with the written words displayed on the user computing device, by automatically advancing a visual indicator to the next written word immediately following the matched written word, so as to indicate that the user is to read the next written word displayed.

5. The method of claim 4, wherein the method further comprises storing a portion of an audio segment that included the user's spoken words that matched with the corresponding written words displayed on the user computing device.

6. The method of claim 3, wherein the visually indicating step includes visually indicating where the error occurred by highlighting, underlining, enlarging a font size, coloring or changing the color of a written word displayed on the user computing device, or any combination thereof, the written word being the word that the user read aloud incorrectly.

7. The method of claim 1, further comprising:
tracking one or more of accuracy, fluency, automaticity, and reading benchmarks of a user, based on the processed first audio segment and at least one of the user's past readings;
storing metrics of the one or more of accuracy, fluency, automaticity, and reading benchmarks of the user; and
displaying the metrics on the user's computing device.

8. The method of claim 8, further comprising:
transmitting personalized user recommendations to the user's computing device based on one or more of a user's profile, the user's tracked metrics, the user's use of warm up tool, the user's use of cool down tool, the user's use of ‘stop the clock’ guided breathing and/or stretching exercises, the time of day at which the user read, the device on which the user read, the user's use of a headphones with a microphone, and the user's past readings of written words from text,
wherein the user's profile comprises one or more of the user's reading level, age, gender, school grade, and the user's selections of fonts, font sizes and contrasts for written words to be displayed on the user's computing device.

9. The method of claim 1, further comprising:
receiving a word selection of one or more of the plurality of written words to zoom in on the word selection to emphasize, the word selection based on user input from the user's computing device for the user to place more emphasis on the word selection while reading it aloud; and
enlarging font size of the selected written word such that the written word appears to be bigger in size than any of the remaining written words displayed on the user's computing device, to visually indicate to the user to emphasize the written word selected.

10. The method of claim 1, wherein one or more of the plurality of written words are presented in a font having a heavier baseline, the font with the heavier baseline appearing to the user as if a regular font is applied on the top portion of a particular letter, while a bold font is applied on the bottom portion of the same letter, the heavier baseline of the font appearing along a bottom portion of letters of the one or more written words to help the user to visually track the written words.

11. (canceled)

12. The method of claim 1, wherein the configurable number of words in the second limited vocabulary for electronic speech recognition is selected from a group of one, two, three, four, five, six, seven, eight, nine, and ten words.

13. The method of claim 1, wherein the configurable number of words in the second limited vocabulary for electronic speech recognition is based at least in part on the speed that the user is reading aloud the first subset of the plurality of written words.

14. The method of claim 1, further comprising:
providing one or more options for additional assistance while the user is reading aloud the first subset of the plurality of written words, where the one or more options comprises:
an option to display a phonetic version of a written word on the user's computing device,
an option to display a syllabized version of the written word on the user's computing device,
an option to hear the written word said correctly by the user in the user's own voice if the user has previously read the word aloud correctly,
an option to skip the written word,
an option to hear the written word, a phrase or a sentence,
an option to read the written word to the user using text to speech,
an option for the user to be prompted with a rhyming word that is different than the written word, and
any combination thereof;
receiving a user selection from the user's computing device of the one or more of the options for additional assistance; and
transmitting the additional assistance to the user's computing device based on the user's selection of the one of more options.

15. The method of claim 1, wherein one or more of the plurality of written words for the user to read aloud are displayed on the computing device in a reading wave, where the reading wave is configured to magnify a subset of the displayed written words that the user should place more emphasis on while reading aloud the written words.

16. The method of claim 1, wherein the first audio segment further comprises one or more of the user's spoken syllables and the user's spoken phonemes.

17. The method of claim 16, further comprises:
synthesizing the one or more of the user's spoken phonemes and the user's spoken syllables, such that one or more of the user's spoken phonemes and the user's spoken syllables are transformed into one of the user's spoken words.

18. The method of claim 16, further comprising:
filtering the one or more of the user's spoken phonemes and the user's spoken syllables;
passing the one or more of the user's spoken phonemes and the user's spoken syllables as sounds to the speech recognition, and
by utilizing speech recognition, reassembling the one or more of the user's spoken phonemes and the user's spoken syllables to detect what is the word that is being said by the user.

19. A method of automated providing reading assistance to a user, the method comprising:
transmitting for display to a user's computing device one or more written words of a given text for the user to read aloud;
indicating to the user, by means of a visual indicator, a selected written word of the one or more written words, the selected written word to be read aloud by the user;
receiving a first audio segment from the user's computing device, the audio segment comprising the user's reading aloud of the selected written word;
processing the first audio segment by utilizing a first limited vocabulary for electronic speech recognition to determine if the user's reading aloud of the selected written word matches with the selected written word, the first limited vocabulary for electronic speech recognition comprising a configurable number of known words in the given text;
building a dynamic second limited vocabulary for electronic speech recognition, the second limited vocabulary comprising a configurable number of known upcoming words in the given text that succeed the written words read aloud by the user in the first audio segment; and
upon determining that the sounds of the user's reading aloud of the selected written word matches with the sounds of the selected written word, automatically advancing the visual indicator to the next written word immediately following the selected written word, so as to indicate that the user is to read the next written word.

20. The method of claim 19, further comprising:
upon determining that the sounds of user's reading aloud of the selected written word do not match with the sounds of the selected written word, transmitting for display to the user's computing device a visual notification that the user did not read the selected written word correctly; and
transmitting for display on the user's computing device one or more options for the user to select, the options comprising an option for the user to read aloud again the selected written word, an option for the user to receive additional assistance, an option for the user to skip the selected written word, and an option for the selected written word to be read aloud to the user via the user's computing device.

21. A method for providing reading assistance to a user, comprising:
transmitting for display to a user's computing device one or more warm up words for the user to read aloud, the one or more warm up words comprising one or more words that the user has previously misread or one or more words not previously encountered by the user;
receiving a first audio segment from the user's computing device, the first audio segment comprising the user's spoken words that were spoken as the user read aloud the one or more warm up words;
processing the first audio segment by utilizing a first limited vocabulary for electronic speech recognition to determine if the user's spoken words match with the one or more warm up words;
transmitting for display to the user's computing device one or more written words from a given text for the user to read aloud;
receiving a second audio segment from the user's computing device, the second audio segment comprising the user's spoken words that were spoken as the user read aloud the one or more written words from the text;
processing the second audio segment by utilizing a second limited vocabulary for electronic speech recognition to determine if the user's spoken words match with the one or more written words from the text;
building a dynamic third limited vocabulary for electronic speech recognition based on known upcoming words in the given text that succeed words in the second limited vocabulary from the given text; and
visually indicating on the user's computing device whether the user's spoken words from the second audio segment matched with the one or more written words from the text.

22. The method of claim 21, further comprising
transmitting for display to the user's computing device one or more cool down words for the user to read aloud, the one or more cool down words comprising one or more words that the user has previously misread or one or more words not previously encountered by the user;
receiving a third audio segment from the user's computing device, the third audio segment comprising the user's spoken words that were spoken as the user read aloud the one or more cool down words;
processing the third audio segment by utilizing a first limited vocabulary for electronic speech recognition to determine if the user's spoken words match with the one or more cool down words; and
visually indicating on the user's computing device whether the user's spoken words from the processed third audio segment matched with the one or more written words from the text.

23. The method of claim 21, further comprising:
tracking an error made by the user, an error comprising a word in the user's spoken words that does not match with the one or more written words, the one or more warm up words, the one or more cool down words, and any combination thereof;
storing an occurrence of the error in a database;
storing a portion of the audio segment of the user's voice that included the error, the audio segment consisting of at least one of the first audio segment, the second audio segment, and the third audio segment; and
replaying at least the portion of the audio segment of the user's voice that included the error when requested by the user.

24. An e-book reader system for providing automated reading assistance to a user, the system comprising:
a memory for storing executable instructions providing reading assistance to a user;
a web server coupled to the memory, the web server configured to generate a graphical user interface that mimics one or more pages of a physical book, the graphical user interface comprising one or more written words of a given text; and
a processor configured to execute the instructions, the instructions being executed by the processor to:
transmit for display to a user's computing device the generated graphical user interface from the web server;
indicate to the user, by means of a visual indicator, a selected word of the one or more written words, the selected word to be read aloud by the user;
receive an audio segment from the user's computing device, the audio segment comprising the user's reading aloud of the selected written word;
process the audio segment by utilizing a first limited vocabulary for speech recognition to determine if the user's reading aloud of the selected written word matches with the selected written word;
building a second limited vocabulary for speech recognition based on known upcoming words in the given text that succeed words in the first limited vocabulary, the known upcoming words comprising upcoming words for the user to read aloud thereafter from the given text;
automatically advance the visual indicator to the next written word immediately following the selected written word, so as to indicate that the user is to read the next written word;
track an error made by the user, an error comprising a word in the user's spoken words that does not match with the one or more written words;
store an occurrence of the error in a database,
store a portion of the audio segment of the user's voice that included the error; and
replay the portion of the audio segment of the user's voice that included the error when requested by the user.

25. The method of claim 1, wherein the building of the second limited vocabulary occurs during the pause.
